(19) United States
(12) Patent Application Publication
(10) Pub. No.: US 2007/0177868 A1
(43) Pub. Date: Aug. 2, 2007

(54) Digital camera and lens assembly

(75) Inventor: Katsumi Saito, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/699,559

(22) Filed: Jan. 30, 2007

(30) Foreign Application Priority Data
Jan. 30, 2006 (JP) 2006-021081

(51) Int. Cl. G03B 17/00

(52) U.S. Cl. 396/529

(57) ABSTRACT

A digital still camera includes a lens assembly having a photographing lens and an image pickup device. A camera body supports the lens assembly. Bayonet lugs as lens mount mechanism couple the lens assembly with the camera body. A retaining mechanism supports the bayonet lugs on the camera body in a slidable manner in a predetermined direction that is crosswise to an optical axis of the photographing lens during connection with the lens assembly, to adjust positioning of the lens assembly in the predetermined direction. In one embodiment, a lens support plate has the bayonet lugs, and is supported on the camera body by the retaining mechanism in a slidable manner. The retaining mechanism includes a rail edge formed with a front of the camera body. An engageable claw is formed with the lens support plate, and received in the rail edge movably in the predetermined direction.

### 1. FIELD OF THE INVENTION

The present invention relates to a digital camera and lens assembly. More particularly, the present invention relates to a digital camera and lens assembly of which a body can be manually held easily for any of various users.

### 2. DESCRIPTION RELATED TO THE PRIOR ART

A digital still camera is known in the field of optical instruments. Shapes of cameras have been improved in consideration of easy handling. To this end, positions, shapes and arrangements of parts are designed from an ergonomic point of view. However, each camera will be used by any of various users or persons who may be adults or children, and may be male or female. Suitable conditions of forms of parts are different between adults and children, for example a position of a lens barrel, a shape of a grip. It is hard to conceive forms of parts suitably for a great number of users no matter how they are modified. A limit exists in the easy degree in the handling.

For the purpose of better holdability to various users, an adjustable structure for positions, shapes or arrangement of parts have been conceived. JP-A 2004-343206 discloses selectable grips, manually operable, associated with a digital camera, having plural sizes different, for being attached to a camera body according to preference. This makes it easy to hold the camera body for hands of users in any of plural sizes.

JP-A 11-231193 discloses a camera in which positions of parts are changeable according to preference of users, and in which a position of a lens on a lens mounting mechanism can be adjusted in the optical axis direction. A screw is disposed outside the camera, and is operable for easily moving the lens in the optical axis direction.

However, JP-A 2004-343206 has a problem in which a set of the exchangeable grips requires preservation so that a user must pay attention to manage various parts including the grips. JP-A 11-231193 discloses the camera in which only an inner structure is changeable. No suggestion is disclosed for an outer shape or size of the camera, so there is no higher manual holdability to users.

### SUMMARY OF THE INVENTION

In view of the foregoing problems, an object of the present invention is to provide a digital camera and lens assembly of which a body can be manually held easily for any of various users.

In order to achieve the above and other objects and advantages of this invention, a digital camera includes a lens assembly having a photographing lens and an image pickup device, and a camera body for recording an image signal from the lens assembly. The digital camera includes a lens mount mechanism for coupling the lens assembly with the camera body. A retaining mechanism supports the lens mount mechanism on the camera body in a slidable manner in a predetermined direction that is crosswise to an optical axis of the lens assembly on the camera body.

The lens mount mechanism includes a lens support plate disposed on the camera body in a slidable manner, and a plurality of bayonet lug portions formed in the lens support plate.

The retaining mechanism includes a rail portion formed with a front of the camera body. A rail engaging portion is formed with the lens support plate, for engagement with the rail portion in a slidable manner.

Furthermore, a tooth group portion is formed with a front of the camera body, has plural teeth, for extending in the predetermined direction. An engageable projection is formed to project from the lens support plate, engaged with the tooth group portion, for positioning the lens support plate stepwise by a selected one of regions of a tooth root of the tooth group portion.

The camera body includes an opening, having a rail edge extending in the predetermined direction, for constituting the rail portion.

The camera body includes an input device for inputting a command signal. A moving mechanism is responsive to the command signal, for sliding the lens support plate.

The moving mechanism includes a rack gear, secured to the lens support plate, for extending in the predetermined direction. A pinion is in mesh with the rack gear. A motor is incorporated in the camera body, for rotating the pinion, to slide the lens support plate with the rack gear.

In one preferred embodiment, a lens assembly for mounting on the camera body in a removable manner is provided. A lens barrel has a photographing lens and an image pickup device incorporated therein. A coupling mechanism is for connection with the camera body. A retaining mechanism supports the coupling mechanism on the lens barrel in a slidable manner in a predetermined direction that is crosswise to an optical axis of the photographing lens, to adjust positioning of the lens barrel in the predetermined direction.

Furthermore, a moving mechanism slides the coupling mechanism relative to the lens barrel.

The retaining mechanism includes a channel formed in one of a front of the coupling mechanism and the lens barrel. A sliding ridge is formed in a remaining one of the front of the coupling mechanism and the lens barrel, and received in the channel.

The moving mechanism includes a rack gear, secured to the front of the coupling mechanism. A pinion is in mesh with the rack gear. A motor is incorporated in the lens barrel, for rotating the pinion, to slide the coupling mechanism with the rack gear.

The retaining mechanism includes at least one channel formed in the coupling mechanism. A receiving hole is formed in a rear panel of the lens barrel. A pin is received in the at least one channel in a slidable manner, and secured to the receiving hole. The channel is slid relative to the pin, to adjust positioning of the coupling mechanism relative to the lens barrel.

The receiving hole is a threaded hole, and the pin is a set screw secured helically to the threaded hole. After position adjustment with the channel, the set screw is further rotated in the threaded hole, to fasten the coupling mechanism on the threaded hole with the channel.

The at least one channel includes a first channel for extending in a first direction. A second channel is formed in connection with the first channel, for extending in a second direction crosswise to the first direction.

The first and second directions are vertical and horizontal directions.

Also, a digital camera includes a camera body, and a lens assembly connected with the camera body, and having a photographing lens and an image pickup device incorporated therein. In the digital camera, the lens assembly includes a lens barrel having the photographing lens and the image pickup device. A coupling mechanism is for connection with the camera body. A retaining mechanism supports the coupling mechanism on the lens barrel in a slidable manner in a predetermined direction that is crosswise to an optical axis of the photographing lens, to adjust positioning of the lens barrel in the predetermined direction.

Furthermore, a moving mechanism slides the coupling mechanism relative to the lens barrel.

### BRIEF DESCRIPTION OF THE DRAWINGS

The above objects and advantages of the present invention will become more apparent from the following detailed description when read in connection with the accompanying drawings, in which:

FIG. 1A is a perspective view illustrating a digital still camera;

FIG. 1B is a rear perspective view illustrating the digital still camera;

FIG. 2 is an exploded perspective view illustrating the digital still camera;

FIG. 3 is a front elevation illustrating a lens support plate of the digital still camera and other elements;

FIG. 4 is a cross section illustrating the digital still camera;

FIG. 5 is a block diagram schematically illustrating circuit elements in the digital still camera;

FIG. 6A is a perspective view illustrating another preferred digital still camera having a motor;

FIG. 6B is a rear perspective view illustrating the digital still camera;

FIG. 7 is a block diagram schematically illustrating circuit elements in the digital still camera;

FIG. 8 is a perspective view illustrating one preferred digital still camera in which a lens assembly has a motor;

FIG. 9 is a cross section illustrating the lens assembly;

FIG. 10 is a block diagram schematically illustrating circuit elements in the digital still camera;

FIG. 11 is a perspective view illustrating still another preferred digital still camera of adjustable positioning in two dimensions;

FIG. 12 is a cross section illustrating a lens assembly of the digital still camera;

FIG. 13 is a perspective view illustrating the lens assembly.

### DETAILED DESCRIPTION OF THE PREFERRED EMBODIMENT(S) OF THE PRESENT INVENTION

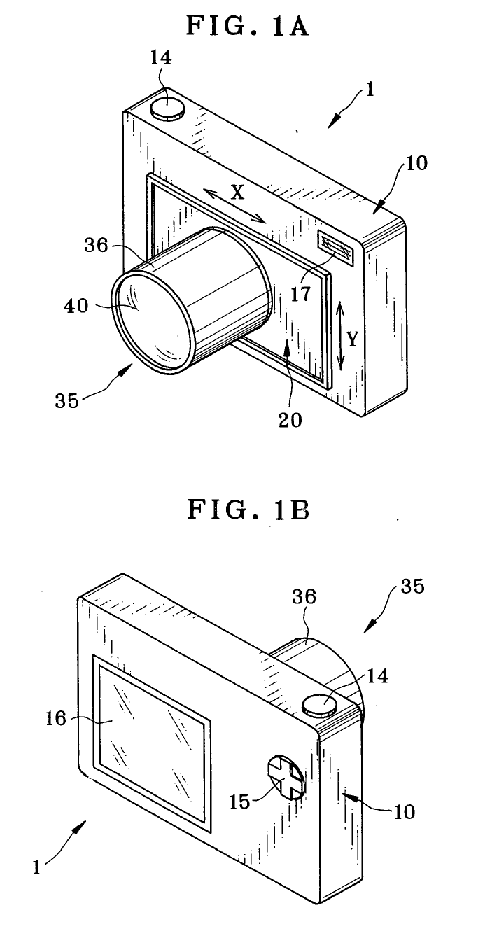

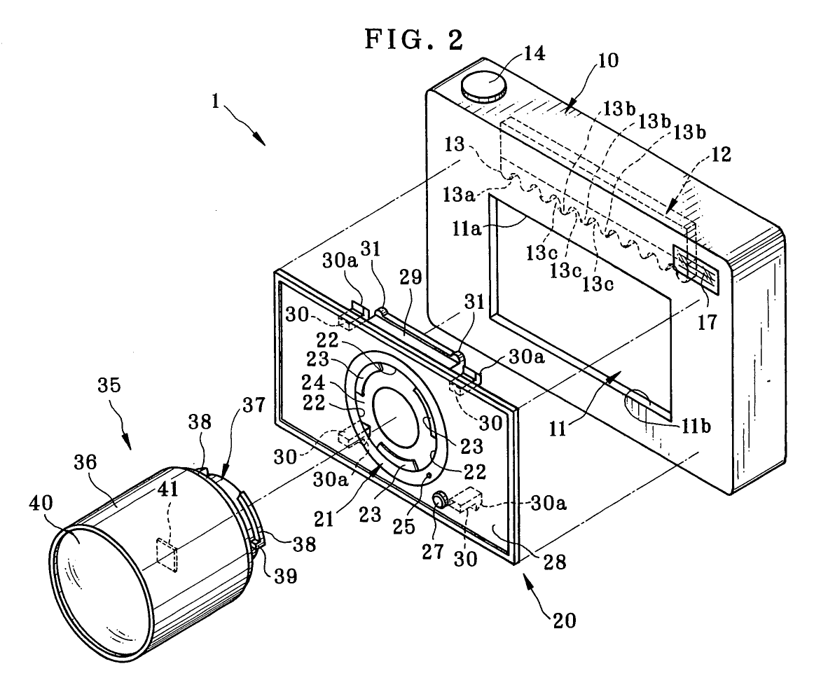

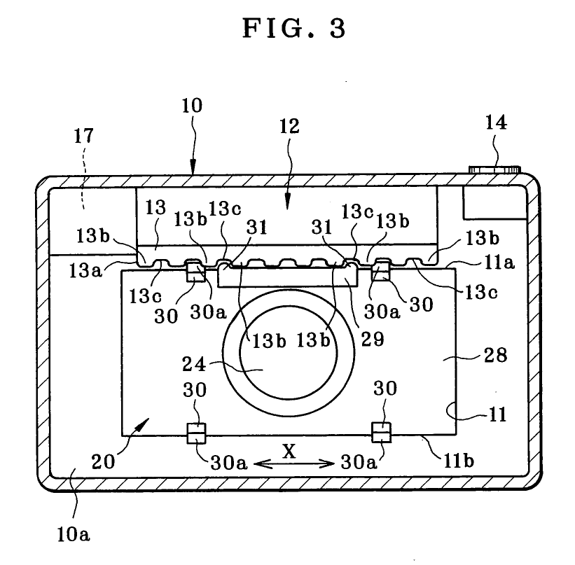

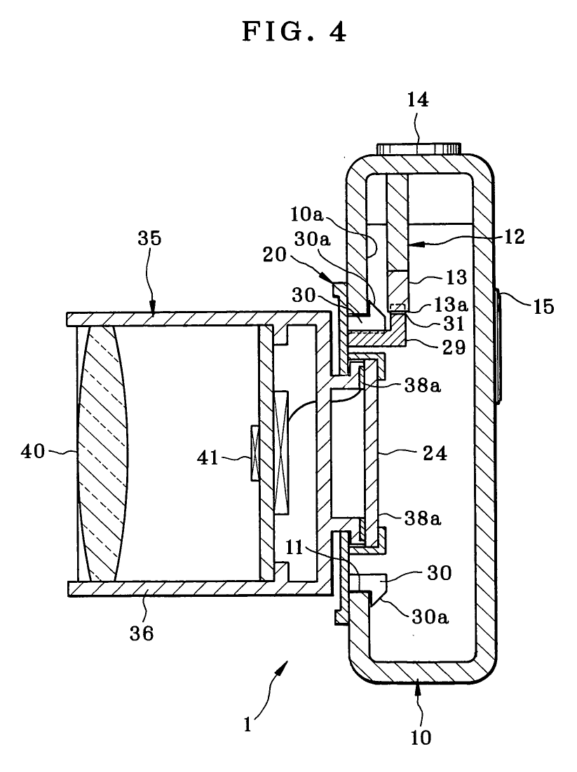

In FIGS. 1A, 1B, 2, 3 and 4, a digital still camera 1 is illustrated. The digital still camera 1 includes a camera body 10, a lens assembly 35 and a lens support plate 20. A quadrilateral support opening 11 as retaining mechanism for adjustment is formed in a front face of the camera body 10. Rail edges 11a and 11b for sliding are defined inside the support opening 11 as opposite sides, and extend horizontally in the camera body 10. The lens support plate 20 includes a panel body 28, a sliding retaining ridge 29 as retaining mechanism for adjustment, and engageable claws 30 or second rail portion. The engageable claws 30 as rail engaging portions protrude from the vicinity of four corners of the panel body 28 in a quadrilateral shape, and are positioned in correspondence with the rail edges 11a and 11b of the support opening 11. A claw end 30a is a tip of each of the engageable claws 30. A shutter button 14 is disposed on an upper face of the camera body 10. A rear of the camera body 10 has a cross shaped keypad device 15 as input device and an LCD monitor display panel 16. A flash light source 17 appears in a front face of the camera body 10.

The sliding retaining ridge 29 of the lens support plate 20 is disposed in the camera body 10 through the support opening 11. An inner surface 10a of the camera body 10 receives engagement of the claw end 30a. The engageable claws 30 contact the rail edges 11a and 11b of the support opening 11 for coupling with the camera body 10 in a slidable manner. The lens support plate 20 is movable in the X direction or horizontally on the camera body 10.

A positioning mechanism 12 is disposed inside an upper portion of the camera body 10. A tooth group 13 is formed with a lower edge of the positioning mechanism 12. A tooth surface 13a of the tooth group 13 is directed down. Teeth 13b are included in the tooth group 13. Between the teeth 13b is located a tooth root 13c in a form of a group of cutouts. The tooth group 13 is formed from resilient material, and deformable when pressed. Engageable projections 31 protrude from an upper face of the sliding retaining ridge 29 of the lens support plate 20, and are engageable with a selected one of regions of the tooth root 13c in the tooth group 13 for stepwise positioning by preventing offsetting. When the lens support plate 20 is slid in the X direction, the engageable projections 31 press and resiliently deform the teeth 13b of the tooth group 13. The engageable projections 31 move over the teeth 13b and become engaged with next one of regions of the tooth root 13c. Thus, the lens support plate 20 can be firmly positioned in plural positions arranged in the X direction, namely five (5) positions according to the structure as depicted.

It is to be noted that the teeth 13b may be formed from rigid material instead of the resilient material. A spring for biasing can be associated with the positioning mechanism 12, to bias the tooth group 13 in the downward direction.

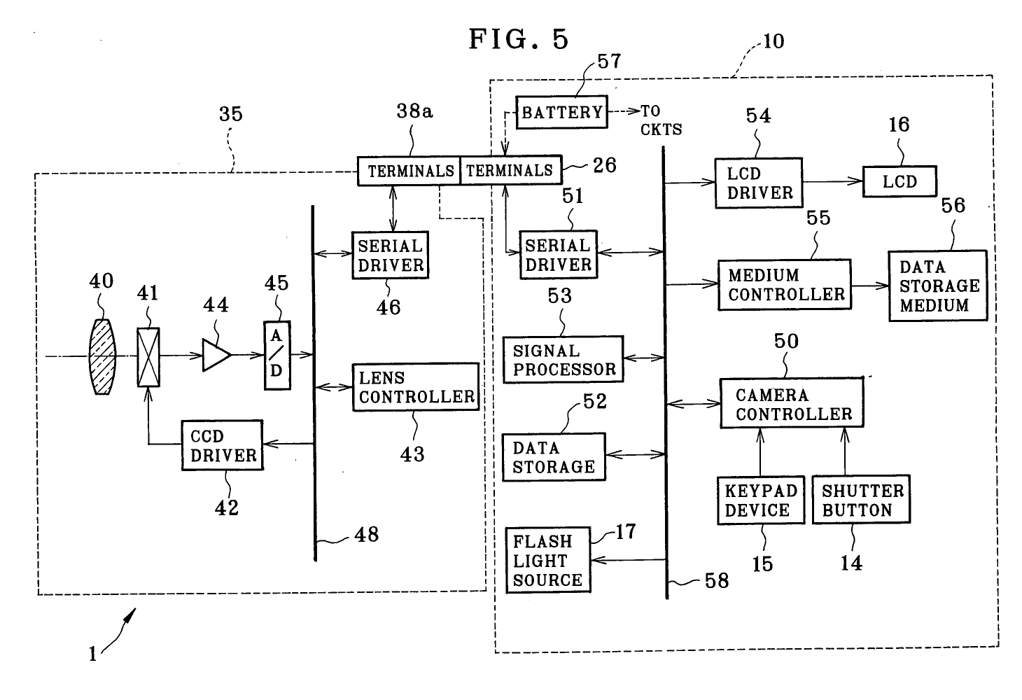

A lens barrel 36 of the lens assembly 35 contains a photographing lens 40 and an image pickup device 41 or CCD image sensor. A coupling mechanism 37 is disposed on the rear of the lens assembly 35. Bayonet lugs 38 protrude as elements of the coupling mechanism 37. Connection terminals 38a are formed on the bayonet lugs 38. Bayonet channels 22 are formed in a lens mount mechanism 21 disposed on the front of the lens support plate 20. To mount the lens assembly 35 on the lens support plate 20, at first the bayonet lugs 38 are positioned at and inserted in the bayonet channels 22 manually, and then rotated about the optical axis. Bayonet lugs 23 project in the front of the lens support plate 20. A positioning projection 39 is formed with the bayonet lugs 38, and when in contact with one of the bayonet lugs 23, determines the rotational positioning of the lens assembly 35. A pin receiving hole (not shown) is formed in the coupling mechanism 37. A lock pin 25 of the lens mount mechanism 21 becomes received in the pin receiving hole, firmly to position the lens assembly 35. Connection terminals 26 (See FIG. 5) are disposed on the lens support plate 20. When the lens assembly 35 is positioned, the connection terminals 38a of the lens assembly 35 are connected with the connection terminals 26. A protector 24 is incorporated in the lens mount mechanism 21, biased in the forward direction of the camera body 10, to prevent dust or other foreign material from entering the camera body 10 while the lens assembly is removed.

An unlocking button 27 is disposed on the lens mount mechanism 21, and associated with the lock pin 25. To remove the lens assembly 35, the unlocking button 27 is depressed to shift the lock pin 25 in the backward direction to unlock the lens assembly 35.

In FIG. 5, circuits in the digital still camera 1 are illustrated schematically. The image pickup device 41 is disposed behind the photographing lens 40. A CCD driver 42 is connected with the image pickup device 41. A lens controller 43 causes the CCD driver 42 to drive the image pickup device 41. The image pickup device 41 converts object light into an image signal, and outputs the image signal. An amplifier 44 amplifies an image signal at a suitable level. An A/D converter 45 converts the image signal into image data of a digital form. A serial driver 46 transmits the image data to the camera body 10. A camera controller 50 generates a command signal according to which the lens controller 43 with a data bus 48 controls photographing operation of the lens assembly 35.

A serial driver 51 is provided with image data from the lens assembly 35. A data storage 52 is accessed, to which the serial driver 51 writes image data. A signal processor 53 reads image data from the data storage 52, and processes the image data to image processing of various conditions, for example gradation conversion processing, white balance (WB) correction, gamma correction, and the like. A monitor display driver 54 is supplied with the processed image data, and causes the monitor display panel 16 to display an image. A live image appears on the monitor display panel 16.

When the shutter button 14 is depressed, a medium controller 55 writes processed image data to a data storage medium 56 after image processing. Also, the flash light source 17 is driven upon depression of the shutter button 14 according to a light amount of illumination in a photographic field. The camera controller 50 sends a command signal to the lens controller 43, and controls various processes in the camera body 10 with a data bus 58, processes of photographing, displaying an image, and writing of data. Also, the shutter button 14 and the cross shaped keypad device 15 are connected electrically with the camera controller 50.

A battery 57 is contained in the camera body 10, and supplies various circuit elements with power in the camera body 10. Also, elements in the lens assembly 35 are supplied with power by the battery 57 through the connection terminals 26 and 38a.

The operation of the digital still camera 1 is described now. For photographing an image, at first the lens assembly 35 of the digital still camera 1 is mounted on the lens support plate 20 on the front of the camera body 10. The lens assembly 35 is electrically connected with the camera body 10. The digital still camera 1 becomes ready for photographing, as the lens assembly 35 is powered and signals can be transmitted and received between the lens assembly 35 and the camera body 10.

While the lens assembly 35 is set on the camera body 10, the lens assembly 35 with the lens support plate 20 is slid by a user in the X direction on the camera body 10. The engageable projections 31 on the sliding retaining ridge 29 of the lens support plate 20 are engaged selectively with regions of the tooth root 13c of the tooth group 13 inside the camera body 10. The lens support plate 20 is firmly set in a selected one of the stepwise positions. The positioning of the lens assembly 35 can be adjusted in the X direction according to preference of the user, to facilitate manual handling of the camera body 10.

In the above embodiment, the position of the lens assembly 35 is adjusted in the X direction. However, the position of the lens assembly 35 may be adjusted in other directions distinct from the X direction, for example Y direction which is a vertical direction.

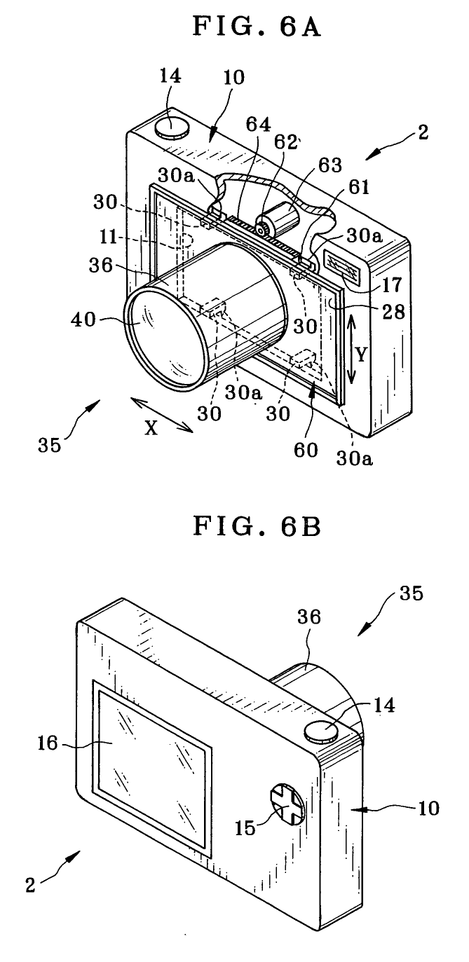

In the above embodiment, the lens assembly 35 in the digital still camera 1 is manually shifted. However, a camera of the invention may be constructed in other forms. A second preferred embodiment is described now. In FIGS. 6A and 6B, a digital still camera 2 includes a lens support plate 60 as well as the camera body 10 and the lens assembly 35. The lens support plate 60 includes the panel body 28, a sliding retaining ridge 61 as retaining mechanism for adjustment and the engageable claws 30. The sliding retaining ridge 61 is located inside the camera body 10 as inserted in the support opening 11.

A motor 63 is contained in an upper portion of the camera body 10. A pinion 62 is secured to an output shaft of the motor 63. A rack gear 64 in a moving mechanism is formed integrally with an upper face of the sliding retaining ridge 61 in the lens support plate 60. The pinion 62 is meshed with the rack gear 64 which is slid by rotation of the motor 63 in the X direction horizontal in the camera body 10. Elements similar to those of the digital still camera 1 are designated with identical reference numerals.

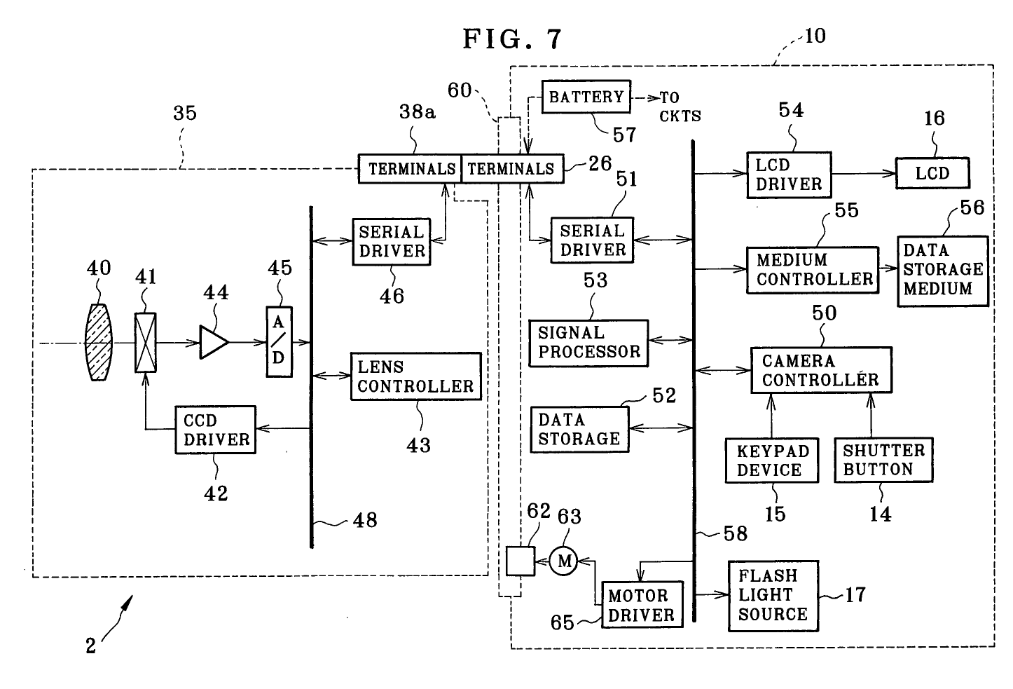

In FIG. 7, arrangement of circuits of the digital still camera 2 are illustrated schematically. A motor driver 65 is connected with the motor 63, and caused by the camera controller 50 to drive the motor 63 in a controlled manner. The camera controller 50 is responsive to command signals output by depression of the cross shaped keypad device 15, and controls the motor 63 for rotation. Elements similar to those of the digital still camera 1 are designated with identical reference numerals.

The operation of the digital still camera 2 is described now. At first the lens assembly 35 of the digital still camera 2 is mounted on the lens support plate 60 on the front of the camera body 10. The lens assembly 35 is electrically connected with the camera body 10. The digital still camera 2 becomes ready for photographing, as the lens assembly 35 is powered and signals can be transmitted and received between the lens assembly 35 and the camera body 10.

When a user depresses the cross shaped keypad device 15 as input device, the camera controller 50 causes the motor driver 65 to drive the motor 63, so the pinion 62 is rotated. The camera controller 50 is responsive to information of a time period in which the cross shaped keypad device 15 remains depressed, and controls a rotating amount of the motor 63 according to the time period. Rotation of the pinion 62 is converted by the rack gear 64 into linear movement, which slides the lens support plate 60 in the X direction. Thus, handling of the camera body 10 is facilitated by the adjustment of the position of the lens assembly 35 in the X direction according to preference of the user.

In the above embodiment, the lens assembly 35 is adjustable in the X direction for the position. However, the position of the lens assembly 35 may be adjusted in other directions distinct from the X direction, for example Y direction which is vertical.

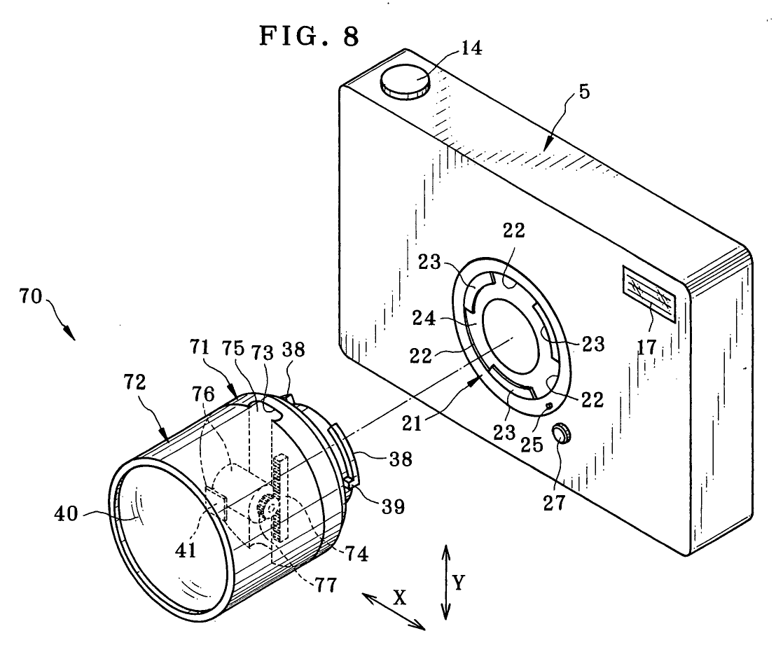

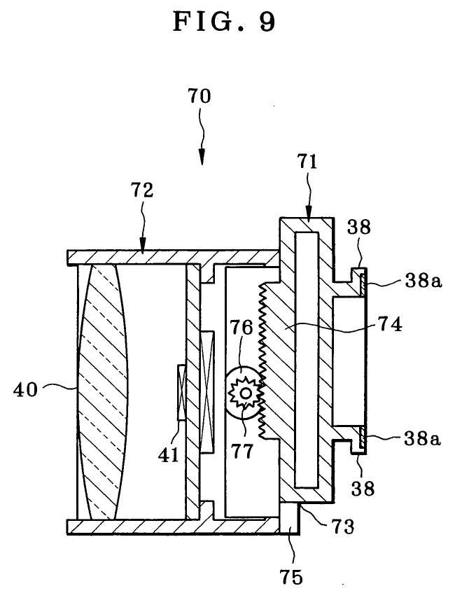

A digital camera of the invention may be constructed without the lens support plate 20 or 60 of the digital still camera 1 or 2 described above. A lens assembly 70 of such a digital camera is described now. In FIGS. 8 and 9, the lens assembly 70 includes a coupling mechanism 71 and a lens barrel 72 containing the photographing lens 40 and the image pickup device 41. The bayonet lugs 38 are disposed on the rear of the coupling mechanism 71 formed cylindrically. A camera body 5 is combined with the lens assembly 70. The lens mount mechanism 21 is disposed on the camera body 5 for coupling the lens assembly 70 with the camera body 5.

A sliding channel 73 as retaining mechanism for adjustment is formed in a front face of the coupling mechanism 71, and extends in the Y direction or vertically with respect to the camera body 5 where the lens assembly 70 is secured. A rack gear 74 as moving mechanism is disposed and extends in parallel with the sliding channel 73. A sliding retaining ridge 75 as retaining mechanism for adjustment is formed on a rear surface of the lens barrel 72, and is received in the sliding channel 73 for keeping the lens barrel 72 slidable on the coupling mechanism 71. A motor 76 is disposed behind the lens barrel 72. A pinion 77 is connected with an output shaft of the motor 76, and meshed with the rack gear 74. When the motor 76 rotates, the lens barrel 72 is caused to slide in the Y direction. For the lens assembly 70 and the camera body 5, elements similar to those of the digital still camera 1 or 2 described above are designated with identical reference numerals.

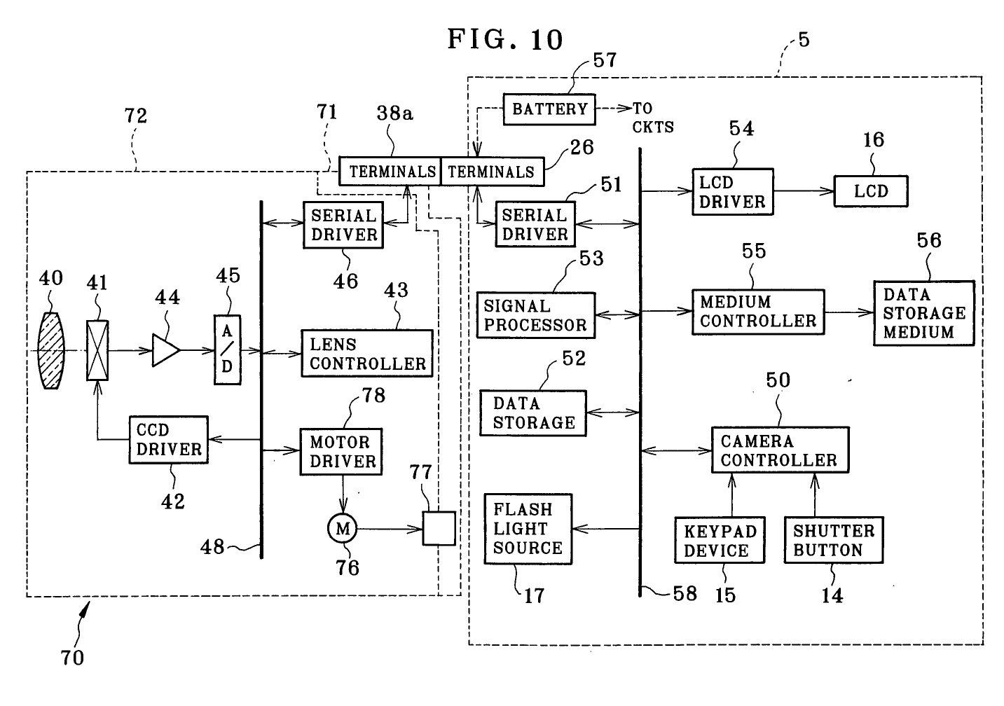

In FIG. 10, circuits in the camera body 5 with the lens assembly 70 are illustrated schematically. A motor driver 78 is connected with the motor 76, and caused by the lens controller 43 to drive the motor 76. The lens controller 43 controls the motor 76 according to control signals from the camera controller 50 which is responsive to command signals generated by operating the cross shaped keypad device 15. Element similar to those of the above embodiments are designated with identical reference numerals.

In operation, at first the lens assembly 70 is mounted on the camera body 5. The lens assembly 70 is electrically connected with the camera body 5. Image pickup is ready, as the lens assembly 70 is powered and signals can be transmitted and received between the lens assembly 70 and the camera body 5.

When the cross shaped keypad device 15 is depressed by a user, the lens controller 43 controls the motor driver 78 to cause the motor 76 to rotate the pinion 77. The lens controller 43 is responsive to information of a time period in which the cross shaped keypad device 15 remains depressed, and controls a rotating amount of the motor 76 according to the time period. The rack gear 74 converts rotation of the pinion 77 into linear movement, to slide the lens barrel 72 in the Y direction at a predetermined amount. The position of the photographing lens 40 is adjusted in the Y direction without structural modification of the camera body 5. The camera body 5 can be shaped in an easily handleable manner according to preference of the user.

In the present embodiment, the photographing lens 40 is adjustable in the Y direction for the position. However, the position of the photographing lens 40 may be adjusted in other directions distinct from the Y direction, for example X direction which is a horizontal direction.

In the above embodiment, the positioning of the photographing lens 40 is adjusted by electric control according to depression of the cross shaped keypad device 15. However, the positioning of the photographing lens 40 may be adjusted by manual operation for shifting.

In spite of the combination of the lens assembly 70 with the camera body 5, it is possible to combine the lens assembly 70 with the camera body 10 of any of the digital still cameras 1 and 2 of the first and second preferred embodiment. The photographing lens 40 can be adjusted for the position in both of the X and Y directions. Manual holdability of the camera body 10 can be ensured because of the higher degree of freedom in the adjustment.

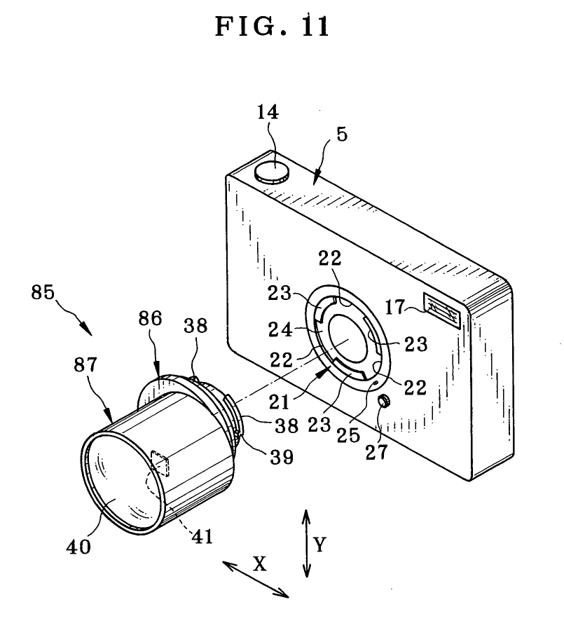

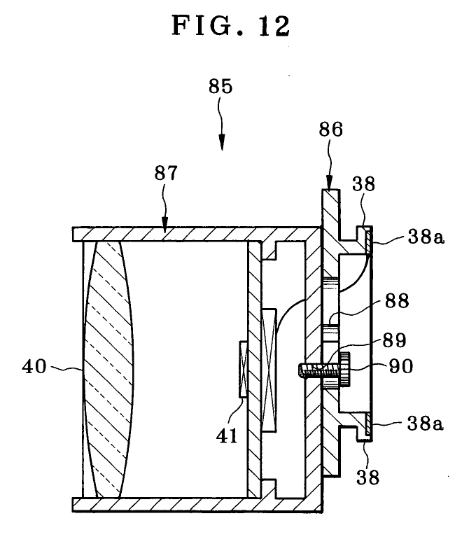

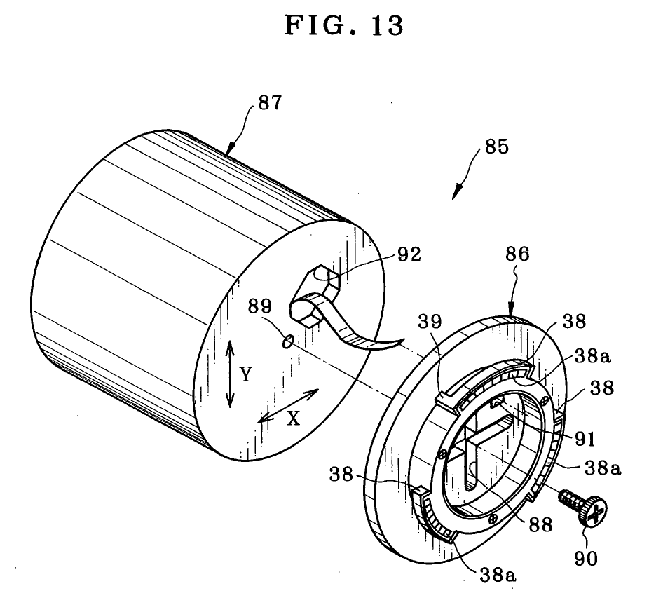

A lens assembly of the invention may be different from the lens assembly 70 of which the photographing lens 40 is adjusted in the Y direction. In FIGS. 11, 12 and 13, one preferred lens assembly 85 is illustrated. The lens assembly 85 includes a lens barrel 87 containing the photographing lens 40 and the image pickup device 41, and a coupling mechanism 86. The lens mount mechanism 21 on the front of the camera body 5 is engaged with the coupling mechanism 86, and couples the lens assembly 85 with the camera body 5.

A cross shaped channel 88 is formed in the center of the coupling mechanism 86, and includes a first channel extending vertically or in the Y direction of the camera body 5 when the lens assembly 85 is secured, and a second channel extending horizontally or in the X direction of the camera body 5. A threaded hole 89 as receiving hole is formed in a rear surface of the lens barrel 87. A rear face of the lens barrel 87 is caused to contact a front face of the coupling mechanism 86 by positioning the threaded hole 89 on the cross shaped channel 88, before a set screw 90 as pin is inserted through the cross shaped channel 88 from the rear, and is secured to the threaded hole 89 loosely in a provisional first step. Then the lens barrel 87 becomes movable or slidable together with the threaded hole 89 in the directions of the form of the cross shaped channel 88, namely in the X and Y directions. After the position of the lens barrel 87 is determined, the set screw 90 is rotated and fastened in a second step of main fastening, to determine the positioning of the lens barrel 87 in an immovable manner. Also, passage holes 91 and 92 are formed in the coupling mechanism 86 and the lens barrel 87, and receives insertion of electric connectors for the image pickup device 41, for example flexible wiring boards. Elements similar to those of the lens assembly 70 are designated with identical reference numerals.

In operation of position adjustment of the lens assembly 85, at first the front of the coupling mechanism 86 is caused to contact the rear of the lens barrel 87 to set the cross shaped channel 88 at the threaded hole 89. The set screw 90 is inserted through the rear of the coupling mechanism 86 into the cross shaped channel 88 for provisional positioning at the threaded hole 89. The lens assembly 85 is constructed by a combination of the coupling mechanism 86 and the lens barrel 87. The lens barrel 87 is adjustable for the position in a two dimensional manner of the X and Y directions by finely adjusting the point of the set screw 90 within the threaded hole 89 according to preference of a user.

The lens assembly 85 is set on the camera body 5, to connect the lens assembly 85 with the camera body 5 electrically as well as mechanically. The camera becomes ready for photographing, as the lens assembly 85 is powered and signals can be transmitted and received between the lens assembly 85 and the camera body 5. Also, handling of the camera body 5 is facilitated because an originally designed shape of the camera body 5 can be modified by a user.

In the present embodiment, the cross shaped channel 88 is formed in the coupling mechanism 86. However, a slot or channel extending only in one direction may be formed in the coupling mechanism 86 in place of the cross shaped channel 88, so that positioning of the lens barrel 87 is adjustable in only one direction.

In the above embodiment, the set screw 90 is removable from the threaded hole 89. However, it is possible that the set screw 90 cannot be separate from the threaded hole 89. The set screw 90 may be rotatable in a state kept inserted in the threaded hole 89, and can be movable between the first step of provisional positioning and the second step of the securing by firm fastening.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A digital camera including a lens assembly having a photographing lens and an image pickup device, and a camera body for recording an image signal from said lens assembly, said digital camera comprising:
a lens mount mechanism for coupling said lens assembly with said camera body; and
a retaining mechanism for supporting said lens mount mechanism on said camera body in a slidable manner in a predetermined direction that is crosswise to an optical axis of said lens assembly on said camera body.

2. A digital camera as defined in claim 1, wherein said lens mount mechanism includes a lens support plate disposed on said camera body in a slidable manner, and a plurality of bayonet lug portions formed in said lens support plate.

3. A digital camera as defined in claim 2, wherein said retaining mechanism includes:
a rail portion formed with a front of said camera body; and
a rail engaging portion, formed with said lens support plate, for engagement with said rail portion in a slidable manner.

4. A digital camera as defined in claim 3, further comprising:
a tooth group portion, formed with a front of said camera body, having plural teeth, for extending in said predetermined direction;
an engageable projection, formed to project from said lens support plate, engaged with said tooth group portion, for positioning said lens support plate stepwise in said predetermined direction.

5. A digital camera as defined in claim 4, wherein said camera body includes an opening in a shape with side lines, having rail edges extending horizontally, for constituting said rail portion.

6. A digital camera as defined in claim 2, wherein said camera body includes:
an input device for inputting a command signal; and
a moving mechanism, responsive to said command signal, for sliding said lens support plate.

7. A digital camera as defined in claim 6, wherein said moving mechanism includes:
a rack gear, secured to said lens support plate, for extending in said predetermined direction;
a pinion in mesh with said rack gear; and
a motor, incorporated in said camera body, for rotating said pinion, to slide said lens support plate with said rack gear.

8. A lens assembly for mounting on said camera body in a removable manner, comprising:
a lens barrel having a photographing lens and an image pickup device incorporated therein;
a coupling mechanism for connection with said camera body; and
a retaining mechanism for supporting said coupling mechanism on said lens barrel in a slidable manner in a predetermined direction that is crosswise to an optical axis of said photographing lens.

9. A lens assembly as defined in claim 8, further comprising a moving mechanism for sliding said coupling mechanism relative to said lens barrel.

10. A lens assembly as defined in claim 9, wherein said retaining mechanism includes:
a channel formed in one of a front of said coupling mechanism and said lens barrel; and
a sliding ridge, formed in a remaining one of said front of said coupling mechanism and said lens barrel, and received in said channel in an engaged manner.

11. A lens assembly as defined in claim 10, wherein said moving mechanism includes:
a rack gear, secured to said front of said coupling mechanism;
a pinion in mesh with said rack gear; and
a motor, incorporated in said lens barrel, for rotating said pinion, to slide said coupling mechanism with said rack gear.

12. A lens assembly as defined in claim 8, wherein said retaining mechanism includes:
at least one channel formed in said coupling mechanism;
a receiving hole formed in a rear panel of said lens barrel;
a pin received in said at least one channel in a slidable manner, and secured to said receiving hole;
said channel is slid relative to said pin, to adjust positioning of said coupling mechanism relative to said lens barrel.

13. A lens assembly as defined in claim 12, wherein said receiving hole is a threaded hole, and said pin is a set screw secured helically to said threaded hole;
after position adjustment with said channel, said set screw is further rotated in said threaded hole, to fasten said coupling mechanism on said threaded hole with said channel.

14. A lens assembly as defined in claim 12, wherein said at least one channel includes:
a first channel for extending in a first direction; and
a second channel, formed with said first channel, for extending in a second direction crosswise to said first direction.

15. A lens assembly as defined in claim 14, wherein said first and second directions are vertical and horizontal directions.

16. A digital camera including a camera body, and a lens assembly connected with said camera body, and having a photographing lens and an image pickup device incorporated therein, said digital camera comprising:
said lens assembly including:
a lens barrel having said photographing lens and said image pickup device;
a coupling mechanism for connection with said camera body; and
a retaining mechanism for supporting said coupling mechanism on said lens barrel in a slidable manner in a predetermined direction that is crosswise to an optical axis of said photographing lens.

17. A digital camera as defined in claim 16, further comprising a moving mechanism for sliding said coupling mechanism relative to said lens barrel.
